(19) United States
(12) Patent Application Publication
(10) Pub. No.: US 2017/0083375 A1
(43) Pub. Date: Mar. 23, 2017

(54) THREAD PERFORMANCE OPTIMIZATION

(71) Applicant: Pontus Networks 1 Ltd., London (GB)

(72) Inventor: Leonardo Martins, London (GB)

(73) Assignee: Pontus Networks 1 Ltd., London (GB)

(21) Appl. No.: 15/311,187

(22) PCT Filed: May 14, 2015
(86) PCT No.: PCT/IB2015/053559

§ 371 Date: Nov. 14, 2016

Related U.S. Application Data
(60) Provisional application No. 62/001,260, filed on May 21, 2014.

(51) Int. Cl. G06F 9/50

(52) U.S. Cl. CPC G06F 9/5033; G06F 9/5066; G06F 9/5044; G06F 9/5055

(57) ABSTRACT

Systems (500, 1100) and methods (1800) for optimizing thread execution in a Target Hardware Platform (“THP”). The methods comprising: constructing a matrix (600) populated with first cost values representing costs of running threads (7080-7085) on computing cores (512-518); determining first performance scores (526) each determined based on the first cost values and a respective thread execution layout of a plurality of different thread execution layouts (900, 1000); selecting an optimal thread execution layout from the plurality of different thread execution layouts based on the plurality of first performance scores; and configuring operations of THP (502) in accordance with the optimal thread execution layout. Each different thread execution layout specifies which threads of a plurality of threads are to respectively nm on the computing cores disposed within THP.

### CROSS REFERENCE TO RELATED APPLICATIONS

This application claims priority under 35 U.S.C. §119(e) to U.S. Provisional Application No. 62/001,260, filed on May 21, 2014, which is incorporated herein by reference in its entirety.

### FIELD OF THE INVENTION

This document relates generally to computing systems. More particularly, this disclosure relates to systems and methods for performance optimization of software components running on a target hardware platform by utilizing modeling techniques to manage software components or threads.

### BACKGROUND OF THE INVENTION

Computing devices are well known in the art. Computing devices execute programmed instructions. A thread of execution is the smallest sequence of programmed instructions that can be managed independently by a scheduler, which is typically part of the operating system. Multiple threads can exist within the same process and share resources in memory. Multithreading is typically implemented by time-division multiplexing. A Central Processing Unit (“CPU”) switches between different threads.

### SUMMARY OF THE INVENTION

The disclosure concerns implementing systems and methods for optimizing thread execution in a target hardware platform. The methods involve: constructing at least one first matrix populated with a plurality of first cost values representing costs of running a plurality of threads on a plurality of computing cores; determining a plurality of first performance scores; selecting an optimal thread execution layout from the plurality of different thread execution layouts based on the plurality of first performance scores; and configuring operations of the target hardware platform in accordance with the optimal thread execution layout. The first performance scores are determined based on the plurality of first cost values contained in the first matrix and a respective thread execution layout of a plurality of different thread execution layouts. More particularly, each first performance score is determined by adding at least two cost values of the plurality of first cost values together. Each different thread execution layout specifies which threads of a plurality of threads are to respectively run on a plurality of computing cores disposed within the target hardware platform.

In some scenarios, a second matrix is constructed that is useful for determining the first performance scores. The second matrix is populated with values determined based on at least one of a modeling formula, a classification of computing cores, attributes of the threads, first affinities of the threads to at least one computing core, second affinities of the threads to other threads, and context switch costs in the target hardware platform.

In those or other scenarios, the values of the first performance scores are adjusted to prevent too many threads from running on a single computing core. For example, a plurality of second performance scores can be determined based on context switch costs in the target hardware platform. Each second performance score is defined by the following mathematical equation

P_{CS}=(t·ln(t)·c)

where P_{CS} is the performance score of context switches. t is the number of threads running in a given computing core. c is a constant representing a context switch cost set as an attribute of a computing device. The second performance scores may be multiplied by a total amount of a central processing unit's resources being used by all the threads running on the given computing core. In this case, the first and second performance scores are respectively added together to obtain a plurality of third performance scores. Also, the optimal thread execution layout is selected based on the plurality of third performance scores instead of the plurality of first performance scores.

### DESCRIPTION OF THE DRAWINGS

Embodiments will be described with reference to the following drawing figures, in which like numerals represent like items throughout the figures, and in which:

FIG. 1 is a schematic illustration of an exemplary architecture for a server having a first thread execution layout.

FIG. 2 is a schematic illustration of an exemplary core distance matrix.

FIG. 3 is a schematic illustration of an exemplary thread management model.

FIG. 4 is a schematic illustration of an exemplary map showing a communication pattern between a plurality of threads.

FIG. 5 is a schematic illustration of an exemplary thread management system.

FIG. 6 is a schematic illustration of an exemplary core distance matrix.

FIG. 7 is a schematic illustration of an exemplary distributed software system.

FIG. 8 is a schematic illustration of an exemplary map showing a communication pattern between a plurality of threads.

FIGS. 9-10 each provide a schematic illustration of an exemplary table specifying an exemplary thread execution layout.

FIG. 11 is a schematic illustration of an exemplary thread management system.

FIG. 12 is a schematic illustration of an exemplary distributed software system.

FIGS. 13A-13C (collectively referred to herein as “FIG. 13”) provide schematic illustrations that are useful for understanding a thread management model.

FIG. 14 is a schematic illustration of an exemplary matrix or table specifying the latency between each network interface card across all network equipment of a target hardware platform.

FIG. 15 is a schematic illustration of an exemplary matrix or table specifying the bandwidth between all of the network interface cards of a target hardware platform.

FIG. 16 is a schematic illustration of exemplary tables indicating the time a data communication takes to reach each computing core of a given server from each NIC.

FIG. 17 is a schematic illustration of an exemplary three dimensional matrix.

FIG. 18 is a flow diagram of an exemplary method for optimizing thread execution in one or more servers.

FIG. 19 is a schematic illustration of an exemplary architecture for a simulator.

### DETAILED DESCRIPTION OF THE INVENTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout the specification may, but do not necessarily, refer to the same embodiment.

Furthermore, the described features, advantages and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present disclosure concerns implementing thread management systems and methods for optimizing performance of a target hardware platform. The methods generally involve: analyzing communication patterns between threads of a software component; and determine an optimal layout for thread execution within a server. Implementations of the present methods: accelerate software applications; improve performance of software applications (e.g., by reducing batch times); reduce processing times of relatively large amounts of data; and reduce operational and capital expenditures (e.g., reduces the number of servers required to be used to perform certain operations).

The present methods are easy to deploy.

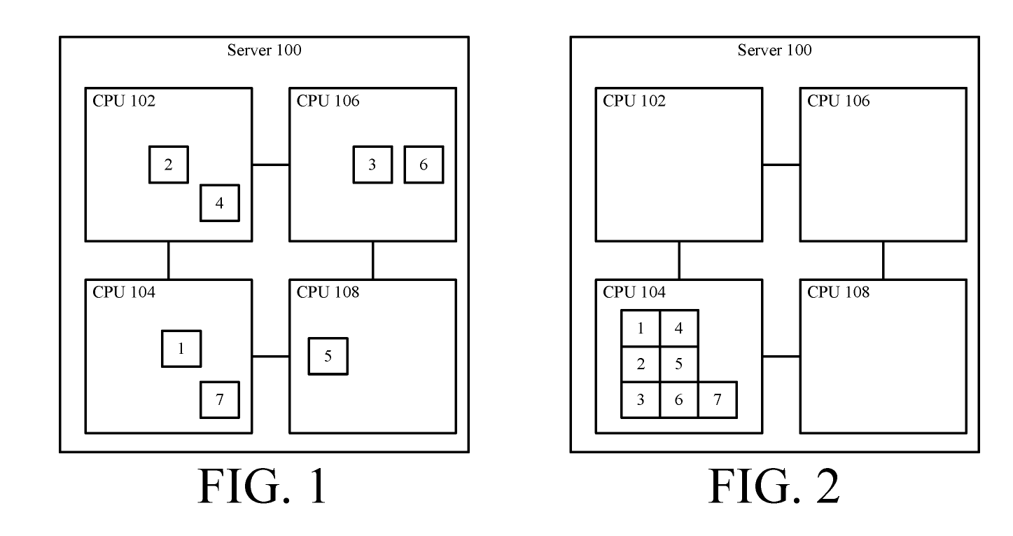

The present methods provide a solution for addressing a natural imbalance that chip manufactures have added in the processors. For example, a server 100 of FIG. 1 comprises four (4) CPUs 102, 104, 106 and 108. A software component can run on the server 100. The software component comprises a plurality of threads 1-7. The term “thread”, as used herein, refers to the smallest sequence of programmed instructions that can be managed independently. Each of the threads can be executed by all of the CPUs 102-108. Also, a plurality of threads can be concurrently executed on a single CPU if the sum of the CPU utilization of the threads requires one hundred percent (100%) or less utilization of the CPU's resources. In this case, there is no control over where the threads are executed. Therefore, execution of the threads is scattered amongst CPUs 102-108. More specifically, threads 1 and 7 are executed by CPU 104. Threads 2 and 4 are executed by CPU 102. Threads 3 and 6 are executed by CPU 106. Thread 5 is executed by CPU 108. However, this default configuration is not optimal in terms of thread-to-thread communications and overall processing time.

In this regard, it should be understood that there is a relatively large penalty or cost when thread processing is distributed amongst the four CPUs. Processing performance of server 100 is lost when the threads 107 need to communicate with each other during execution thereof by a plurality of CPUs. As such, the present invention provides a means for determining an optimal layout for thread execution on a server. This determination is made based on results obtained from simulating processing performance of a server in accordance with a plurality of different thread execution layouts. The different thread execution layouts are selected using: (a) a hardware model of a server specifying the CPUs and corresponding data connections therebetween; and (b) a software model specifying the software component's threads and required data exchanges therebetween.

The speed at which a CPU executes a given thread can be over one hundred (100) times slower depending on the relative distance between the CPU and a memory that needs to be accessed by the CPU during execution of the given thread. For instance as shown by the following DISTANCE RATIO TABLE, access speed is relatively fast when the CPU accesses a level 1 cache, a level 2 cache and level 3 cache. The access speed is slower when the CPU accesses local memory, and even slower when the CPU access remote memory from a neighboring CPU.

DISTANCE RATIO TABLE

| Level 1 | Level 2 | Level 3 | Local | Remote | No-Cross |
|---|---|---|---|---|---|
| Cache | Cache | Cache | Memory | Memory | Bridge Memory |
| 1 | 2 | 6 | 10 | 83 | 113 |

The present technique tries to reduce these costs from a modeling perspective.

An exemplary optimal layout is shown in FIG. 2. Generally, optimal processing performance of server 100 can be achieved when threads 1-7 are all executed on CPU 104. Thus, server 100 is configured to operate in accordance with the optimal layout, i.e., threads 1-7 are all executed by CPU 104.

Notably, conventional operating systems are unable to properly configure thread execution by the CPUs of a respective sever because of the complexity of the problem. For example, in a financial services scenario, there are sixty-four (64) cores and two hundred (200) threads. The total number of possible thread execution solutions is the total number of cores to the power of threads (i.e., 64200=10³⁶¹) which is an extremely complex problem to solve by hand. The operating systems do not have enough time to make optimal thread layout decisions when it is scheduling executions of the two hundred (200) threads by the sixty-four (64) cores.

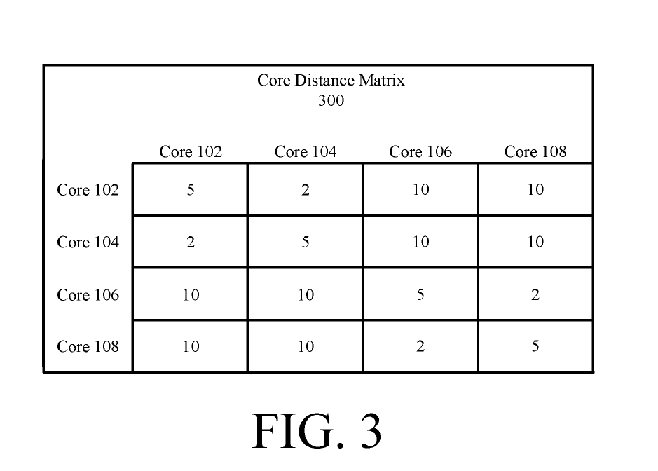

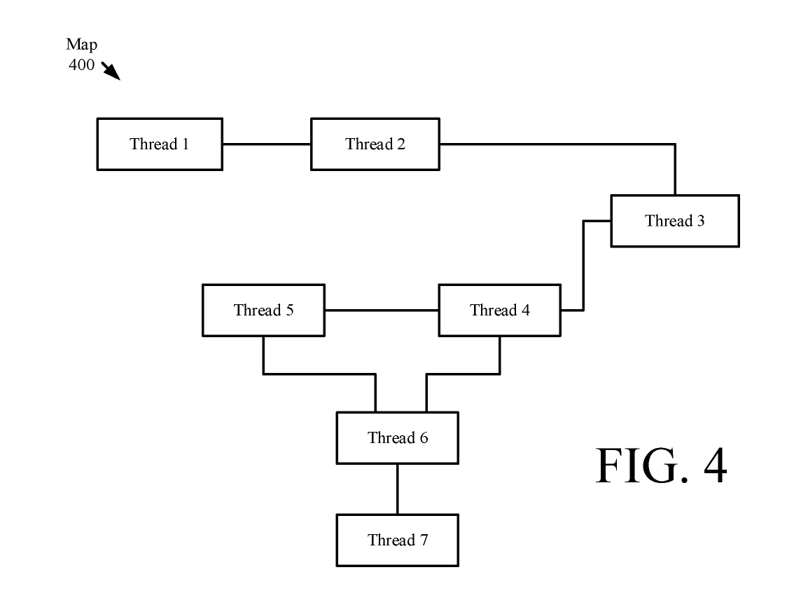

Therefore, the present solution provides a novel Self-Tuning Mode (“STM”) technique to thread execution optimization. The STM technique employs an agent that does the following: collects information about the hardware of a server (e.g., physical distances between cores of a server); generates at least one matrix including the collected information (e.g. matrix 300 of FIG. 3 specifying the distances between cores); and generates a map (e.g., map 400 of FIG. 4) showing the communication patterns between the threads of a software component running on the server. The matrix and map are sent to a simulator for use in a subsequent simulation process. The simulator may reside on the server or a remote device.

At the simulator, a linear programming technique is used to simulate operations of the server in accordance with a plurality of possible thread execution layouts. The matrix contents are used as constraints for the linear programming, while the threads are moved around in the software program. A performance score is computed for each simulation. The performance score is computed based on: physical distances between communicating threads; and context switches (e.g., thread executions waiting for completion of another's thread's processing).

The performance scores are sent from the simulator to the agent. The agent then uses the thread execution layout which is associated with the lowest performance score to configure operations of the server. Notably, the performance scores and thread execution layouts can be stored by the agent for later reference and use in re-configuring the server. This allows the shortening of simulation cycles over time.

In some scenarios, some or all of the agent's operations are performed by a user, and the simulations are run offline. Accordingly, a Graphical User Interface (“GUI”) is provided with the simulator. The GUI allows a user to define a hardware architecture, generate matrices, generate a map of thread communication patterns, and compare performance scores to select which thread execution layout is to be implemented in the server.

The present invention will now be described in more detail in relation to a plurality of example thread management systems. The present invention is not limited to the particulars of the following examples.

The thread management systems described below may be used by (1) performance-tuning specialists to plan resource allocation, (2) operating system schedulers to allocate resources, (3) an automatic agent to improve the operating system schedulers' resource allocations, and/or (4) a cloud computing resource manager to allocate resources in a more performance-friendly fashion. The thread management systems may each have three main components: (a) a target hardware platform; (b) an agent; and (c) a simulator. Component (a) has various attributes that affect how the performance score(s) is(are) computed by the simulator. These attributes include, but are not limited to, a name or label attribute to identify components throughout a system and costs (or physical distances) associated with communicating data between said components.

### First Example

### Thread Management System

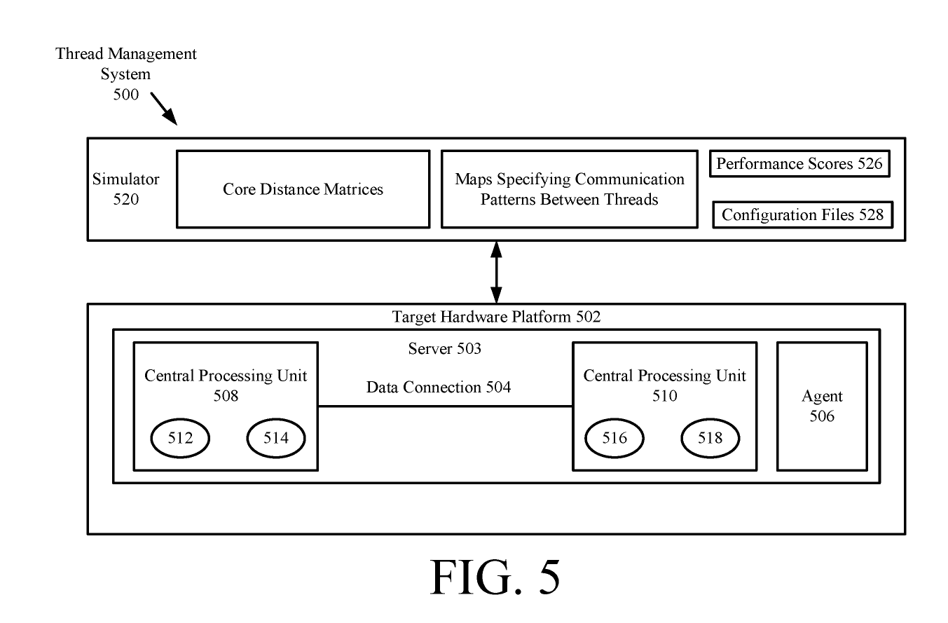

Referring now to FIG. 5, there is provided a schematic illustration of an exemplary thread management system 500. The thread management system 500 comprises a target hardware platform 502 and a simulator 520. Simulator 520 is shown as being located remote from the target hardware platform 502. In some scenarios, the simulator 520 is alternatively disposed within the target hardware platform 502.

The simulator 520 provides a self-tuning system that automatically adjusts the thread management strategy based on the behavior of the system and limitations of the hardware. The simulator 520 may be implemented with one or more computing devices that include at least some tangible computing elements. For example, the computing device may be a laptop computer, a desktop computer, a Graphical Processing Unit (“GPU”), a co-processor, a mobile computing device such as a smart phone or tablet computer, a server, a smart television, a game console, a part of a cloud computing system, or any other form of computing device. The computing device(s) may perform some or all processes such as those described below, either alone or in conjunction with one or more other computing devices. The computing device(s) preferably include or access storage for instructions and data used to perform the processes.

The target hardware platform 502 comprises a single server 503. The server 503 has two CPUs 508 and 510 communicatively coupled to each other via a data connection 504. Each CPU has two computing cores 512, 514 or 516, 518. Each computing core is an independent actual processing unit configured to read and execute program instructions or threads of a software component.

An agent 506 is also executed on server 503. Agent 506 is generally configured to facilitate optimization of thread execution by CPUs 508 and 510. In this regard, agent 506 performs operations to determine the physical distance between the cores 512-518 of the CPUs 508 and 510. Methods for determining these physical distances are well known in the art, and therefore will not be described herein. Any known or to be known method for determining physical distances between computing cores can be used herein without limitation.

Next, a core distance matrix 600 is generated using the previously determined physical distances. The core distance matrix 600 specifies physical characteristics of the server (or stated differently, the costs or distances associated with communicating data between different pairs of the computing cores 512-518). For example, the cost for communicating data from computing core 512 to computing core 512 has a value of five (5). The cost for communicating data from computing core 512 to computing core 514 has a value of two (2). The cost for communicating data from computing core 512 to computing core 516 has a value of ten (10), etc.

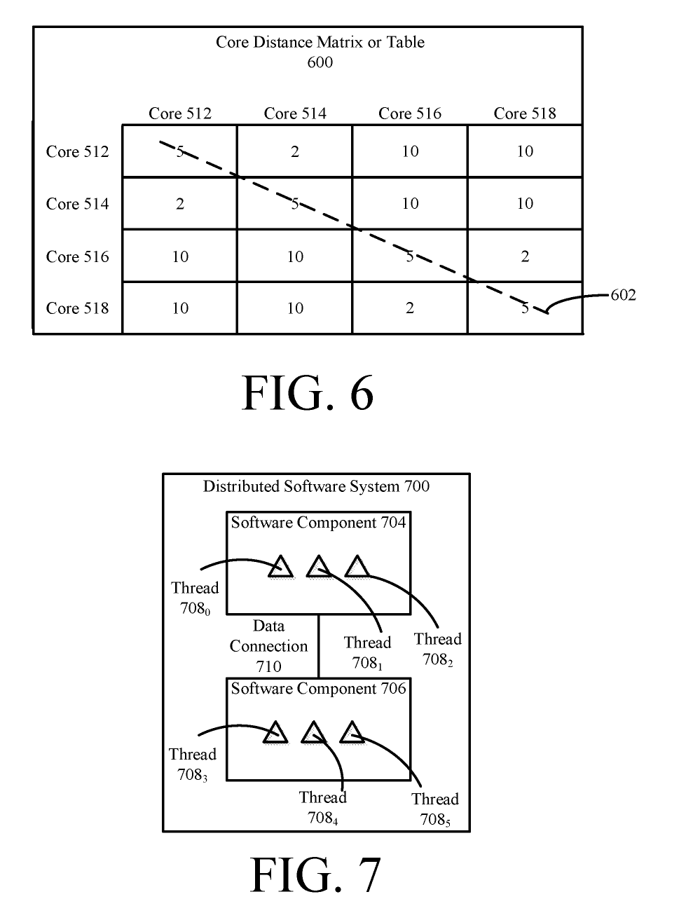

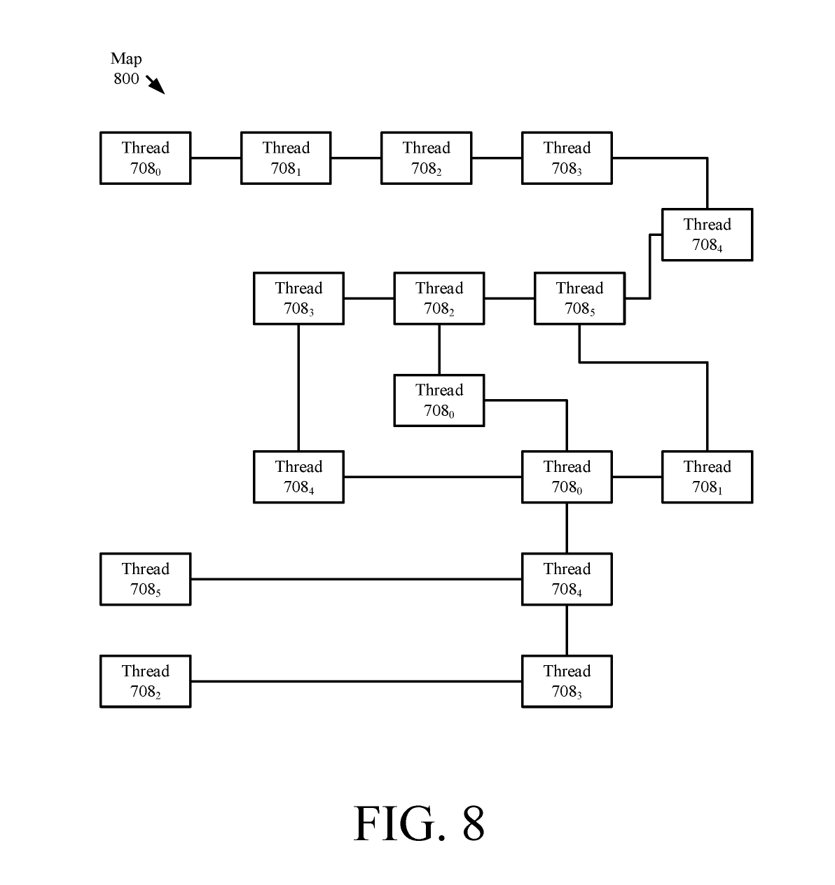

With reference to FIG. 6, it should be understood that the costs of sending data between each set of cores 512/514, 512/516, 512/518, 514/516, 514/518 depend on the hardware topology of server's CPUs 508 and 510. Thus in some scenarios, the cost values of matrix 600 are obtained using measurement data reflecting the communication speed between computing cores and/or distance information from system manuals. For example, if two computing cores share the same level 1 and level 2 caches, then there is a relatively fast communication path therebetween. Accordingly, the cost or distance between these two computing cores is assigned a value of two (2). In contrast, if two computing cores are located in separate CPUs, then processing jumps from one CPU to another CPU. This results in a relatively slow communication path between the computing cores. In effect, the cost or distance between these two computing cores is assigned a value of ten (10).

Notably, the cost associated with communicating data within a single computing core is assigned a value of five (5), as shown by diagonal line 602. This cost value is higher than the cost value associated with data communication between two computing cores of the same CPU (e.g., cores 512 and 514). This cost value structure ensures (or biases the model so) that too many threads do not concurrently run on any given computing core.

Additionally, the agent 506 performs operations to collect information about a distributed software system 700 employed by server 503. The distributed software system 700 comprises two software components 704 and 706. Each software component comprises a plurality of threads 708₀, 708₁, 708₂ or 708₃, 708₄, 708₅. A map 800 is generated by the agent which shows the communication pattern between the threads 708₀-708₅.

The matrix 600 and map 800 are sent to the simulator 520 for use in a subsequent simulation process. At the simulator, a linear programming technique is used to simulate operations of the server 503 in accordance with a plurality of possible thread execution layouts. The thread execution layouts can be defined in table format. The matrix contents are used as constraints for the linear programming, while the threads are moved around in the software program.

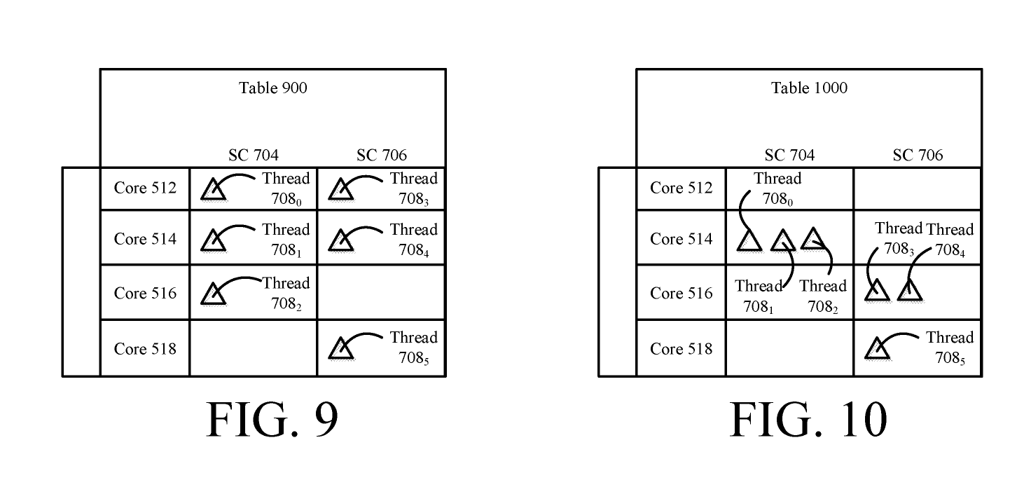

Two exemplary thread execution layout tables 900 and 1000 are provided in FIGS. 9-10. As shown in FIG. 9, a first thread execution layout indicates that: thread 708₀ of software component 704 is executed by core 512; thread 708₁ of software component 704 is executed by core 514; thread 708₂ of software component 704 is executed by core 516; thread 708₃ of software component 706 is executed by core 512; thread 708₄ of software component 706 is executed by core 514; and thread 708₅ of software component 706 is executed by core 518. As shown in FIG. 10, a second thread execution layout indicates that: threads 708₀, 708₁, 708₂ of software component 704 is executed by core 514; threads 708₃, 708₄ of software component 706 are executed by core 516; and threads 708₅ of software component 706 is executed by core 518.

A performance score 526 is computed by the simulator 520 for each simulation cycle. The performance score 526 is computed based on: the costs associated with communicating data between threads as specified in the core distance matrix 600; and/or context switches as defined below. For example, let's assume that: a thread running on computing core 512 is communicating with another thread running on computing core 518; and a thread running on computing core 514 is communicating with another thread running on computing core 512. In this case, the performance score of cost P_{cost} is computed by adding two cost values together as shown by the following mathematical equation (1).

P_{cost}=10+2=12 (1)

To prevent too many threads from running on the same physical core, a performance score of context switches is computed using the following context switch mathematical equation (2).

P_{CS}=(t·ln(t)·c) (2)

where P_{CS} is the performance score of context switches. t is the number of threads running in a given core. c is a constant representing the context switch cost set as an attribute of a server. Notably, the value of P_{CS} increases as the number of threads running simultaneously on a given core increases. Also, P_{CS} may be multiplied by the total CPU utilization of all the threads running on the given core.

P_{CS} may be added to P_{cost} to obtain a final performance score P_{bias}, as shown by the following mathematical equation (3).

P_{bias}=P_{cost}+P_{CS} (3)

As noted above, the performance score can be computed by adding together the cost of sending data between two threads within one software component 504 or 506. The affinity of each of the threads to the computing cores dictates the cost to send data between the threads. When software components 704 and 706 have a data connection 710, the threads 708₀ and 708₃ associated with the connection are also added to the calculation. Thus, the computations are performed to determine the cost of sending data between threads 708₀, 708₁, 708₂ and thread 708₃ and the cost of sending data between threads 708₃, 708₄, 708₅ and thread 708₀.

As an example, let's assume that: the ‘context switch’ penalty in server 503 is a value of zero (0); the software components 704 and 706 do not have any restrictions on which computing cores its threads may run; all threads have the same priority and have zero percent (0%) performance utilization; data connection 710 has a weight of one (1); and neither the data size attribute nor the Boolean flag indicating whether the threads communicate with each other are present. In this scenario, the performance score P_{cost} for the thread execution layout of FIG. 9 is calculated by adding the cost of sending data between the following threads:

(A) 708₀→708₁, 708₂, and 708₃ (because of the data connection 710)
(B) 708₁→708₀, 708₂, and 708₃ (because of the data connection 710)
(C) 708₂→708₀, 708₁, and 708₃ (because of the data connection 710)
(D) 708₃→708₄, 708₅, and 708₀ (because of the data connection 710)
(E) 708₄→708₃, 708₅, and 708₈ (because of the data connection 710)
(F) 708₅→708₃, 708₄, and 708₀ (because of the data connection 710)

Accordingly, the performance score P_{cost} has a value of one hundred twenty-two (122), which was computed as follows.

$$\begin{matrix}\begin{matrix}{P}_{cost} = {P}_{cost ( A )} + {P}_{cost ( B )} + {P}_{cost ( C )} + {P}_{cost ( D )} + {P}_{cost ( E )} + {P}_{cost ( F )} \\ = 17 + 14 + 30 + 17 + 14 + 30 \\ = 122\end{matrix} & ( A ) \\ {P}_{cost ( A )} = 17 & \end{matrix}$$

708₀→708₁=2 (because the cost between computing cores 512 and 514 in FIG. 6 is 2)
708₀→708₂=10 (because the cost between computing cores 512 and 516 in FIG. 6 is 10)
708₀→708₃=5 (because the cost between computing cores 512 and 512 in FIG. 6 is 5)

### (B) P_{cost(B)}=14

708₁→708₀=2 (because the cost between computing cores 512 and 514 in FIG. 6 is 2)
708₁→708₂=10 (because the cost between computing cores 514 and 516 in FIG. 6 is 10)
708₁→708₃=2 (because the cost between computing cores 514 and 512 in FIG. 6 is 2 and there is no context switch penalty between these two threads)

### (C) P_{cost(c)}=30

708₂→708₀=10 (because the cost between computing cores 516 and 512 in FIG. 6 is 10)
708₂→708₁=10 (because the cost between computing cores 516 and 514 in FIG. 6 is 10)
708₂→708₃=10 (because the cost between computing cores 516 and 512 in FIG. 6 is 5 and there is no context switch penalty between these two threads)

### (D) P_{cost(D)}=2+10+5=17

### (E) P_{cost(E)}=2+10+2=14

### (F) P_{cost(F)}=10+10+10=30

Similarly, the performance score P_{cost} for the thread execution layout of FIG. 10 is calculated by adding the cost of sending data between threads. In this case, the performance score P_{cost} equals one hundred and eight (108), and is computed at follows.

$$\begin{matrix}{P}_{cost ( A )} = 5 + 5 + 10 = 20 & ( A ) \\ {P}_{cost ( B )} = 5 + 5 + 10 = 20 & ( B ) \\ {P}_{cost ( C )} = 5 + 5 + 10 = 20 & ( C ) \\ {P}_{cost ( D )} = 5 + 2 + 10 = 17 & ( D ) \\ {P}_{cost ( A )} = 5 + 2 + 10 = 17 & ( E ) \\ {P}_{cost ( F )} = 2 + 2 + 10 = 14 & ( F )\end{matrix}$$

As noted above, the context switch costs from server 503 were zero (0). If instead the context switch costs were higher (e.g., a value of 30), the performance scores above would have to be added to the following values (rounded up to the next integer).

For thread execution layout of FIG. 9:
P_{CS}=(2*ln(2)*30)=˜42 (because threads 708₀ and 708₃ are running on computing core 512)
P_{CS}=(2*ln(2)*30)=˜42 (because threads 708₁ and 708₄ are running on computing core 514)
P_{CS}=(1*ln(1)*30)=0 (because one thread 708₂ is running on computing core 516)
P_{CS}=(1*ln(1)*30)=0 (because one thread 708₅ is running on computing core 518)
For thread execution layout of FIG. 10:
P_{CS}=(0*ln(0)*30)=0 (because zero threads are running on computing core 512)
P_{CS}=(3*ln(3)*30)=˜99 (because threads 708₀-708₃ are running on computing core 514)
P_{CS}=(2*ln(2)*30)=˜42 (because threads 708₃ and 708₄ are running on computing core 516)
P_{CS}=(1*ln(1)*30)=0 (because one thread 708₅ is running on computing core 518)

The foregoing calculations indicate that the thread execution layout of FIG. 10 is less attractive than the thread execution layout of FIG. 9 as it has three threads 708₀--708₃ competing for resources of the same core 514. Consequently, the simulator generates a configuration file 528 using the thread execution layout of FIG. 9. The configuration file 528 is then sent to the agent 506 so that the sever 503 can be configured to implement the thread execution layout of FIG. 9.

### Second Example

### Thread Management System

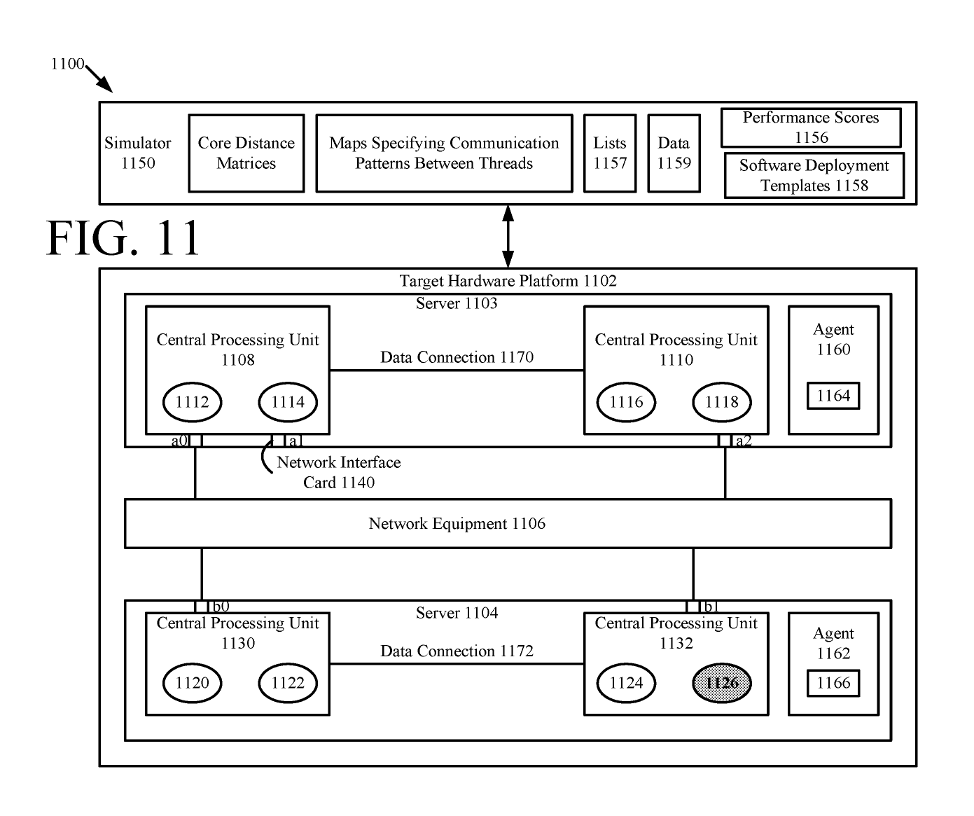

Referring now to FIG. 11, there is provided a schematic illustration of an exemplary thread management system 1100 that is useful for understanding the present invention. Thread management system 1100 comprises a target hardware platform 1102 and a simulator 1150. Simulator 1150 is shown as being located remote from the target hardware platform 1102. In some scenarios, the simulator 1150 is alternatively disposed within the target hardware platform 1102.

The thread management platform 1100 comprises a plurality of servers 1103, 1104 communicatively coupled to network equipment 1106 via network interface cards 1140. Components 1106, 1140 have bandwidth and latency attributes. The network equipment 1106 includes, but is not limited to, switches, routers, firewall, and/or cables.

Each server 1103, 1104 includes a plurality of CPUs 1108, 1110, 1130, 1132 electrically connected to each other via data connections 1170, 1172. Each CPU has one or more computing cores 1112-1126. Each computing core is an independent actual processing unit configured to read and execute program instructions or threads. Agents 1160, 1162 are provided to control the thread execution layout of the servers 1103, 1104, respectively. In this regard, each agent executes a thread management software application 1164 or 1166 that may be part of the server's operating system. The thread management software 1164, 1166 may include instructions which do not allow the threads to be run on certain computing cores (e.g., computing core 1126). This arrangement allows the agents 1160, 1162 to reserve resources for any non-performance critical applications.

The simulator 1150 provides a self-tuning system that automatically adjusts the thread management strategy based on the behavior of the system and limitations of the hardware. The simulator 1150 may be implemented with one or more computing devices that include at least some tangible computing elements. For example, the computing device may be a laptop computer, a desktop computer, a GPU, a co-processor, a mobile computing device such as a smart phone or tablet computer, a server, a smart television, a game console, a part of a cloud computing system, or any other form of computing device. The computing device(s) may perform some or all processes such as those described below, either alone or in conjunction with one or more other computing devices. The computing device(s) include or access storage for instructions and data used to perform the processes.

The simulator 1150 has the following items stored therein: core distance matrices; maps specifying communication patterns between threads; lists 1157; and data 1159. Each of the listed items was generated by the agents 1164 and 1166, and communicated to the simulator 1150 from the agents for use in computing performance scores 1156.

The lists 1157 include a list of memory zones 0, . . . , n that correlate to the computing cores, where n is the number of CPUs in a respective server. The memory zones and their sizes may be used to calculate performance scores 1156 and to determine a memory area that is closest to a given computing core.

The data 1159 includes, but is not limited to, bus width data, cache size data, main memory cost data, and/or context-switch cost data. The main memory cost data specifies a penalty for accessing a main memory to obtain a thread management layout therefrom. The context-switch cost data specifies a penalty for running too many threads from different software components on the same computing core.

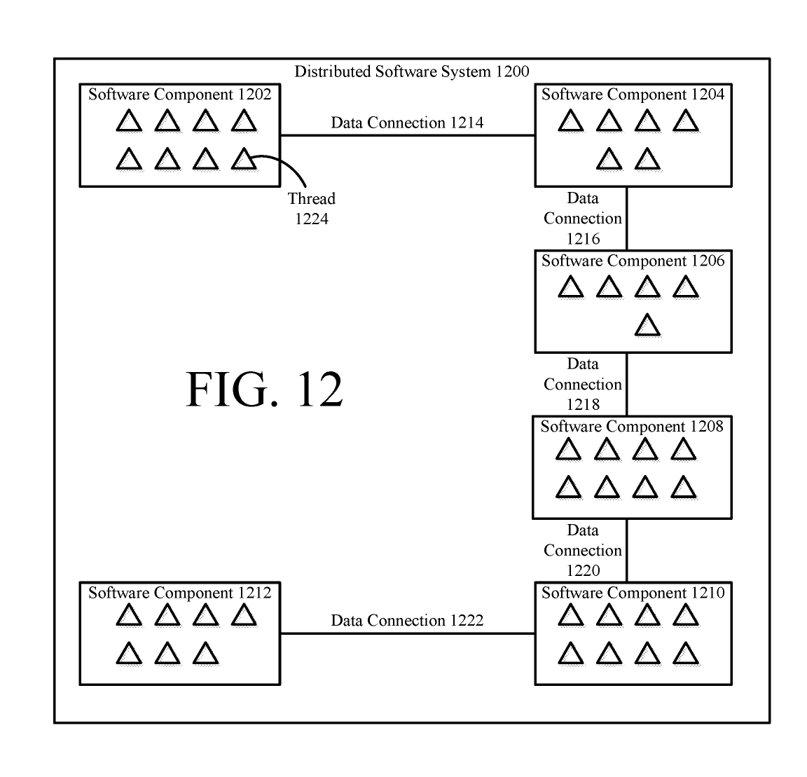

Referring now to FIG. 12, there is provided a schematic illustration of an exemplary distributed software system 1200 employed by system 1100. As shown in FIG. 12, the distributed software system 1200 comprises a plurality of software components 1202-1212 communicatively coupled to each other via data connections 1214-1222. The data connections 1214-1222 provide a means to transfer data between software components. Each software component 1202-1212 comprises a whole executable process, a portion of a process, interrupt request handlers, and/or drivers. As such, each software component 1202-1212 comprises a plurality of threads 1224. Each software component 1202-1212 may have a cache hit ratio associated therewith. The cache hit ratio indicates how often the data flowing between threads of a respective software component is expected to hit a cache and not go to a main memory of a server.

Various information is associated with each data connection. This information includes, but is not limited to, a list of source and destination threads, a weight value, size values, protocols, latency figures, expected bandwidth values, a cache hit ratio, and a Boolean flag. The weight value indicates a strength and weakness of a data transfer relationship between two software components. The plurality of size values may include the following: a first size value specifies the size of data to be passed between threads of a software component; a second size value specifies a bus width; and a third size value specifies a cache size of a server. If the first size value is present, then the second and third size values can be used to calculate a penalty for sending data between threads of a software component. In scenarios where a data connection does not have a first size value associated therewith, the second and third size values may be ignored. The Boolean flag indicates whether or not a destination connection thread should communicate with all other threads in a software component. By default, the Boolean flag may be assumed to be “true” if the flag is absent. The required memory sizes can be used as additional constraints for a simulation process.

Each software component 1202-1212 has certain information associated therewith. This information includes, but is not limited to, a list of performance utilization, a list of computing cores where a software component is allowed to be run, list of servers in which the computing cores exist, list of thread priorities, and/or attributes. The list of performance utilization may comprise percentages (each ranging from 0 to 100%) or other computational metrics. Notably, threads of a software component can run on any core listed in the list of computing cores. The lists of computing cores and servers can be used to reduce the search space of a thread management problem. The list of thread priorities allows an operating system to bias high-priority threads before allocating lower-priority threads. The attributes may include a list of character strings naming threads. The character string list helps specialists easily identify which thread needs to be pinned to each computing core.

Each software component 1202-1212 further has a list of advanced modeling formulas associated therewith, which may be added by a user to add penalties to the performance score for each thread. The modeling formulas allow users to take any thread management layout attributes (e.g., cache hit ratio and main memory cost) and refer to them therein. The modeling formulas are then used by the simulator 1150 to calculate the performance score(s) 1156.

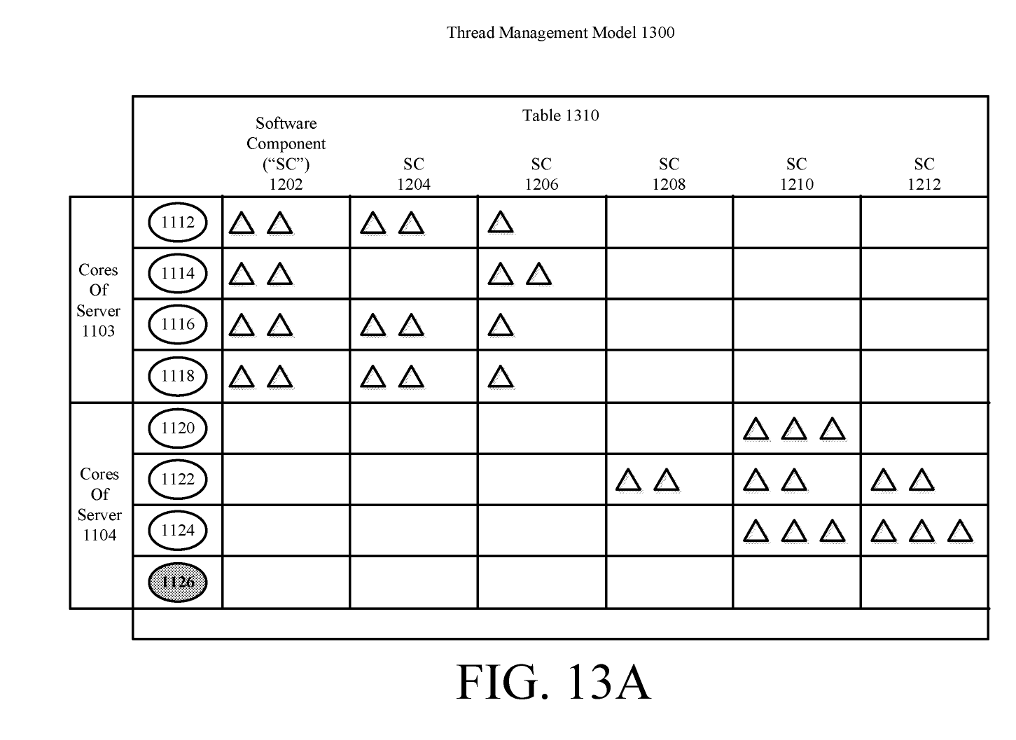

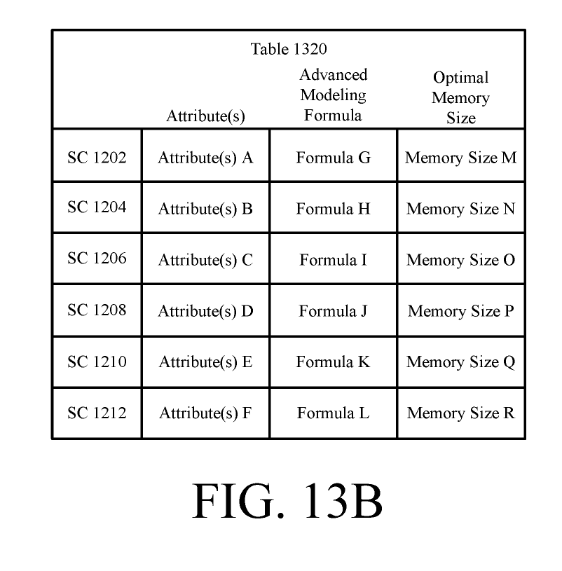

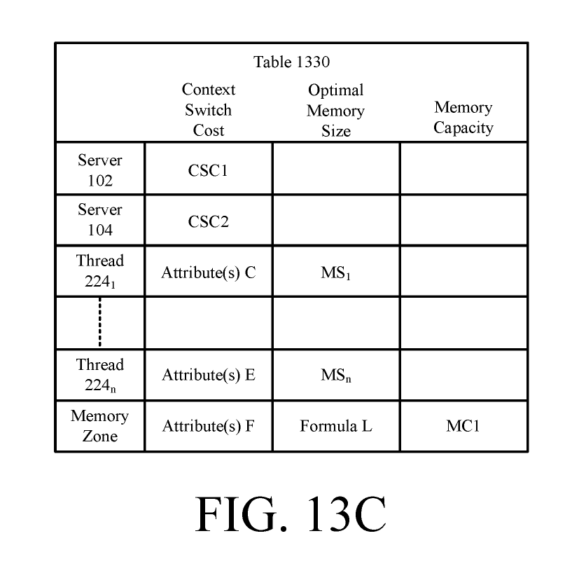

Referring now to FIG. 13, there is provided a schematic illustration of an exemplary thread management mode 1300. Thread management mode 1300 specifies a plurality of parameters that are useful for computing performance scores 1156. All or a subset of the parameters specified by the thread management mode 1300 may be used to compute a performance score 1156.

In some scenarios, the thread management model 1300 is in the form of one or more tables 1310-1330. Each table of the thread management model 1300 comprises a plurality of rows and columns. For example, a first table 1310 includes rows that are respectively associated with the cores (e.g., cores 1112-1126 of FIG. 11) contained in a target hardware platform (e.g., target hardware platform 1100 of FIG. 11). As such, each row has a respective core identifier (e.g., 1112-1116) associated therewith. The columns are associated with software components (e.g., software components 1202-1212 of FIG. 12) of a distributed software system (e.g., distributed software system 1200 of FIG. 12). Accordingly, each column has a respective software component identifier (e.g., 1202-1212) associated therewith. Each cell of the thread management model 1300 (which corresponds to a respective core identifier and software component identifier) includes information indicating which threads of a given software component can be run on a particular core of a server (e.g., server 1103 or 1104 of FIG. 11). This information is useful for computing performance scores. Alternatively or additionally, table 1310 indicates the affinity of threads of each software component to each core.

A second table 1320 comprises a plurality of rows and a plurality of columns The rows are associated with the software components (e.g., software components 1202-1212 of FIG. 12) of a distributed software system (e.g., distributed software system 1200 of FIG. 12). As such, each row has a respective software component identifier (e.g., 1202-1212) associated therewith. The rows are associated with various characteristics of the software components. These characteristics include, but are not limited to, attributes of the software components, a custom advanced modeling formula for each software component, and optimal memory sizes of each software component. This information is useful for computing performance scores.

A third table 1330 comprises a plurality of rows and a plurality of columns The rows are associated with the servers (e.g., servers 1103-1104 of FIG. 11) of a target hardware platform (e.g., target hardware platform 1100 of FIG. 11), threads 1224₁, . . . , 1224ₙ (e.g., threads 1224 of FIG. 12), and memory zones related to the CPUs (e.g., CPUs 1108, 1110, 1130, 1132 of FIG. 11) of the target hardware platform. The columns are associated with characteristics of the servers, threads and memory zones. The characteristics include, but are not limited to, context switch costs, optimal memory sizes, and memory capacity. Accordingly, table 1330 specified the context switch costs of each server, optimal memory sizes of each thread, and the memory capacity of the memory zones related to the CPUs. This information is useful for computing performance scores.

In some scenarios, the thread management model 1300 comprises a three dimensional management matrix. A first dimension of the matrix comprises the cores. A second dimension of the matrix comprises a list of software components. A third dimension of the matrix comprises various combinations of network paths.

Notably, in the scenarios in which the target hardware platform comprises a single server as shown in FIG. 5, the third dimension of the matrix does not have any values or alternatively may be viewed as having a single value. In effect, the three dimensional management matrix becomes a two dimensional management matrix. The two dimensional matrix values can be lists of threads including thread names, thread performance utilization (e.g. CPU %), and/or thread priority.

The thread management model 1300 may be displayed graphically and/or be put in software deployment templates 1158. The software deployment templates 1158 store many of a software application's deployment properties. The software deployment templates 1158 can be created using a deployment template wizard. The software deployment templates 1158 may allow the thread management model 1300 to be applied to an actual software application. The software deployment templates 1158 may be used to create scripts that enable software components (e.g., software components 1202-1212 of FIG. 12) and/or threads (e.g., threads 1224 of FIG. 12) to be pinned to correct cores (e.g., cores 1112-1126 of FIG. 11) outside the simulated environment. Additionally or alternatively, the thread management model 1300 may be sent to automatic agents 506, 1164, 1166 that can dynamically enable the software components and/or threads to be pinned to the correct cores outside the simulated environment.

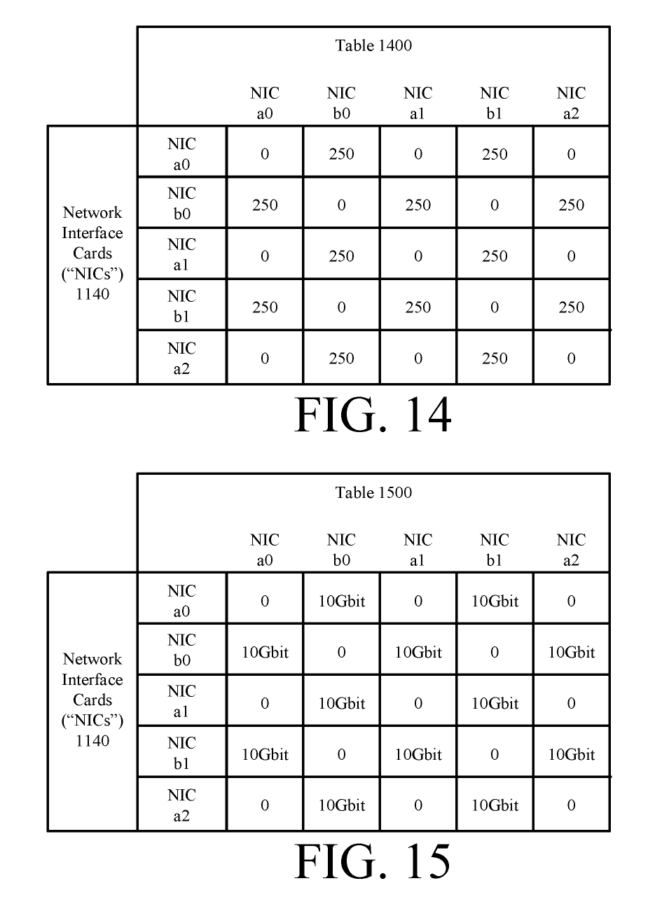

Referring again to FIG. 11, the target hardware platform 1102 has two servers 1103 and 1104. As such, the cost of sending data between any two cores 1112-1126 may also encompass the latency of any NIC 1140 and network equipment 1106. In this regard, three matrices or tables are required which specify the costs for data to flow between various cores. Additionally, at least one matrix or table is required which specifies the latency and/or bandwidth between the NICs and/or computing cores. A schematic illustration of an exemplary table 1400 specifying the latency between each NIC 1140 across all network equipment 1106 of the target hardware platform 1100 is provided in FIG. 14. A schematic illustration of an exemplary table 1500 specifying the bandwidth between all of the NICs 1140 is provided in FIG. 15. Schematic illustrations of exemplary tables 1600 and 1610 indicating the time a data communication takes to reach each computing core of a given server from each NIC. These matrices or tables contain values that are derived from various attributes of the target hardware platform 1100. More specifically, tables 1400-1610 are derived by taking attributes from the NICs 1140, network equipment 1106 and computing cores 1112-1126.

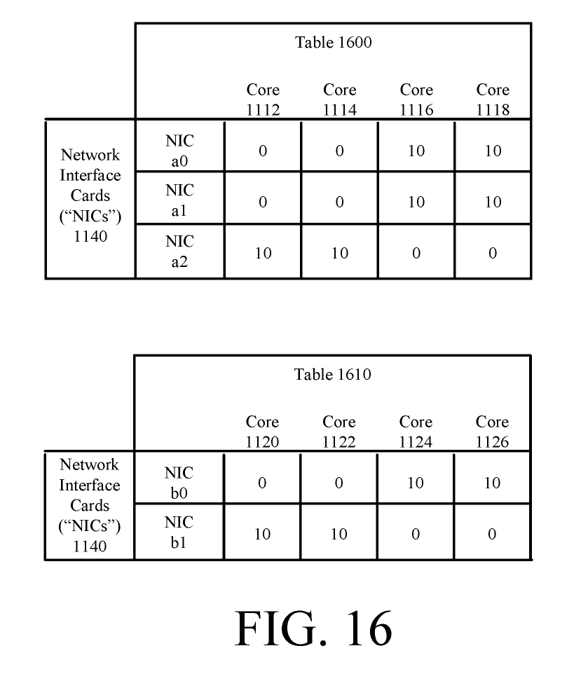

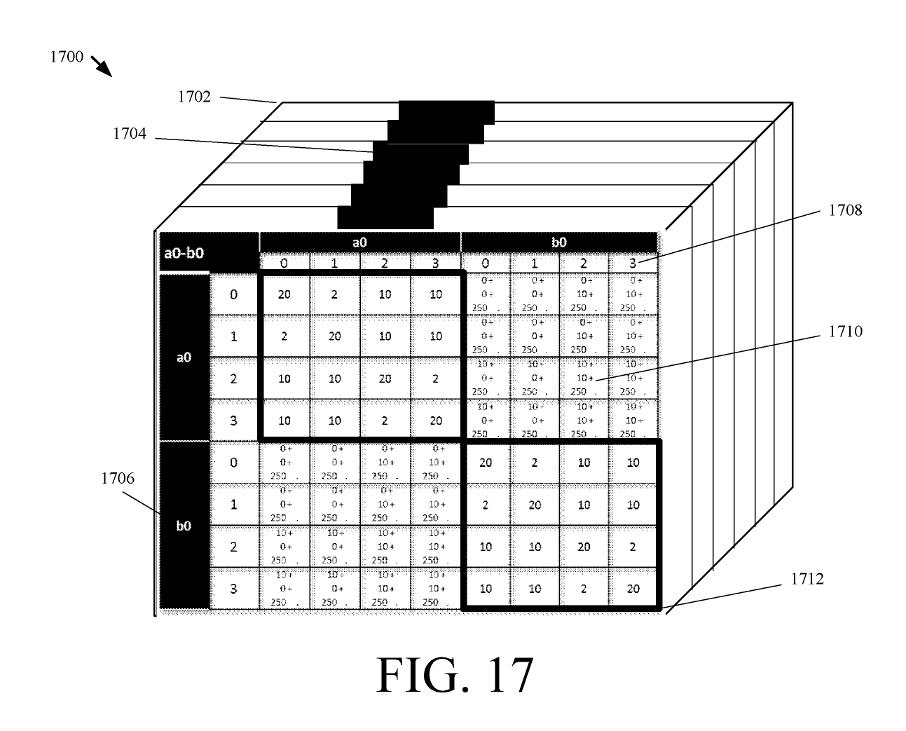

Referring now to FIG. 17, there is provided a schematic illustration of an exemplary three dimension matrix 1700 with values derived from matrices or tables 600 of FIG. 6, 1400 of FIG. 14, 1600 of FIG. 16 and 1610 of FIG. 16. Matrix 1700 can be used by simulator 1150 to compute performance scores 1156. The first two dimensions of matrix 1700 are lists of the computing cores 1112-1126 for each server 1103, 1104. The computing cores 1112-1126 are grouped by NICs 1104 in both the first two dimensions. The third dimension 1704 of matrix 1700 is a combination of NICs 1140 used to communicate between the servers 1103, 1104 in the target hardware platform 1100. This combination of NICs 1140 may range from one specific path to the Cartesian product of all NICs 1140 in all target hardware platform 1100. The matrix 1700 is filled with the data costs between all computing cores 1112-1126 in the whole target hardware platform 1100.

The cost of sending data between the computing cores 1112-1126 in the same server 1103 or 1104 are shown in the individual server matrix 1712. Individual server matrices 1712 for each server are laid diagonally. Note that the values of individual server matrices 1712 are the same as the values of the matrix shown in FIG. 6.

In order to calculate the data costs of each of the cross-server path cells 1710, three values are required according to aspects of the subject technology. As an example, the three values of cell 1710 in the intersection of row a0:2 and column b0:2 may be calculated as follows.

(1) The cost of sending data between core 1708 and NIC 1706 for this column of the matrix (e.g., b0:2) is derived by looking up cell b0:2 in matrix 1610 of FIG. 16. In this cross-server path cell 1710, the value is ten (10).
(2) The cost of sending data between core 1708 and NIC 1706 for this row of the matrix (e.g. a0:2) is derived by looking up cell a0:2 in matrix 1600 of FIG. 16. In this cross-server path cell 1710, the value is ten (10).
(3) The cost of sending data between NIC 1706 in the row and column of cross-server path cell 1710 is derived by looking up cell a0:b0 in matrix 1400 of FIG. 14 cell. In this cross-server path cell 1710, the value is two hundred fifty (250).

Notably, the matrix 1700 may be used to determine the best thread 1224 allocation in all computing cores 1112-1126 for all software components 1202-1212. With the information in matrix 1700, the simulator 1150 may also select optimal NICs 1140 to use in cross-server communication for each data connection 1214-1222.

In general, the simulator 1150 may be driven by re-assigning the threads 1224 to different computing cores 1112-1126, and by selecting various combinations of NICs 1140 across machines until a low score appears. The simulator 1150 may also be driven automatically by using linear programming techniques. When using linear programming techniques, the following constraints (1)-(5) can be used to drive the simulator 1150.

(1) The sum of all performance utilizations of all the threads running on a single computing core must be less than or equal to the total capacity of computing core (usually 100%, but could also be any computational metric indicating the total performance available to that single core).
(2) The threads must only run in the list of allowed cores for a given software component. (If the list is empty or does not exist, the threads may run in any core).
(3) No threads may run on certain computing cores (e.g., computing core 1126 of FIG. 11).
(4) If present, the bandwidth of a data connection (e.g., data connection 1214 of FIG. 12) must not exceed the bandwidth of the NICs in the matrix or table 1500 of FIG. 15.
(5) If present, the latency of a data connection (e.g., data connection 1214 of FIG. 12) must be greater than the selected target hardware path (e.g., if the latency of data connection is one hundred (100), the path used to communicate with the neighboring software component should not have a higher cost than one hundred (100)).

When using linear programming techniques to drive the simulator 1150 automatically, the following results should be sought: the performance score of context switches should be optimized; and the performance score of costs to send data between threads should be optimized. When using linear programming techniques to drive simulator 1150 automatically, the following variables should be modified: the affinity of each of thread to the computing cores; and the various network path combinations of NICs and network equipment to use between servers.

The data for both the target hardware platform 1100 and the distributed software system 1200 attributes may be collected via automated scripts or in some other manner. When automating the capture of the distributed software system data 1159, the thread management system 1100 may become self-tuning. An agent 1164, 1166 may collect the software system data 1159 periodically, as well as the target hardware platform data 1159 (in case it is a virtual environment or a dynamic environment where the hardware characteristics are dynamic). The simulator 1150 would then re-run the simulation, and dynamically apply the results back to actual running processes automatically. When running the thread management system 1100 in an automated fashion, there is a risk of re-allocating threads too frequently, which may result in poor performance results. To prevent this from happening, the agent 1164, 1166 should have configurable thresholds to determine how often to re-tune the thread management system 1100. In addition, to increase the performance of the automated thread pinning calculations, previous results may be cached and re-used if the data for software system 1200 and target hardware platform 1100 was previously calculated.

Exemplary Method For Optimizing Thread Execution Of A Server

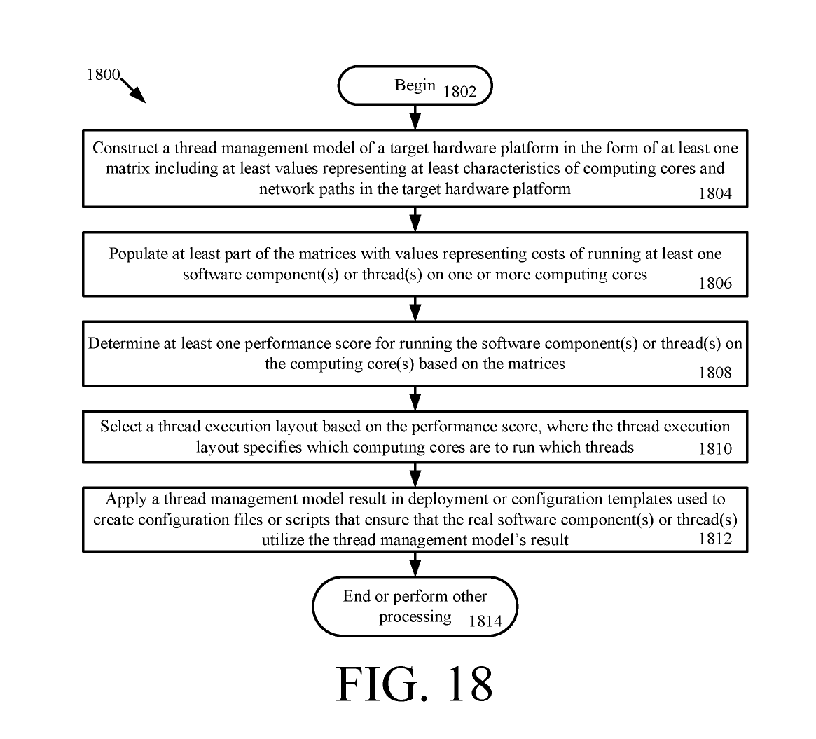

Referring now to FIG. 18, there is provided a flow diagram of an exemplary method 1800 for optimizing thread execution in one or more servers (e.g., server 503 of FIG. 5, server 1103 of FIG. 11 and/or server 1104 of FIG. 11). Method 1800 begins with step 1802 and continues with step 1804 where a thread management model (e.g., thread management model 1300 of FIG. 13) of the target hardware platform (e.g., target hardware platform 502 of FIG. 5 or 1102 of FIG. 11) is constructed in the form of at least one matrix or table (e.g., matrix or table 300 of FIG. 3, 600 of FIG. 6, 1320 of FIG. 13B, 1330 of FIG. 13C, 1400 of FIG. 14, 1500 of FIG. 15, 1600 of FIG. 16, 1610 of FIG. 16, and/or 1700 of FIG. 17) including values representing characteristics of computing cores (e.g., computing cores 512-518 of FIG. 5 and/or 1112-1126 of FIG. 11), and network paths in the target hardware platform. In a next step 1806, the matrices and/or tables are populated. For example, a matrix or table is populated with values representing costs of running at least one software component or thread on the computing cores.

Upon completing step 1806, step 1808 is performed where one or more performance scores (e.g., performance scores 526 of FIG. 5 and/or 1156 of FIG. 11) are determined. The performance score(s) is(are) determined using the matrices or tables generated in previous steps 1804-1806. A thread execution layout (e.g., thread execution layout 900 of FIG. 9, 1000 of FIG. 10, or 1310 of FIG. 13A) is then selected in step 1810 based on the performance score(s). The thread execution layout specifies which computing cores are to run which threads of a plurality of threads. The target hardware platform is then configured to operate in accordance with the selected thread execution layout, as shown by step 1812. Subsequently, step 1814 is performed where method 1800 ends or other processing is performed.

Exemplary Simulator Architecture

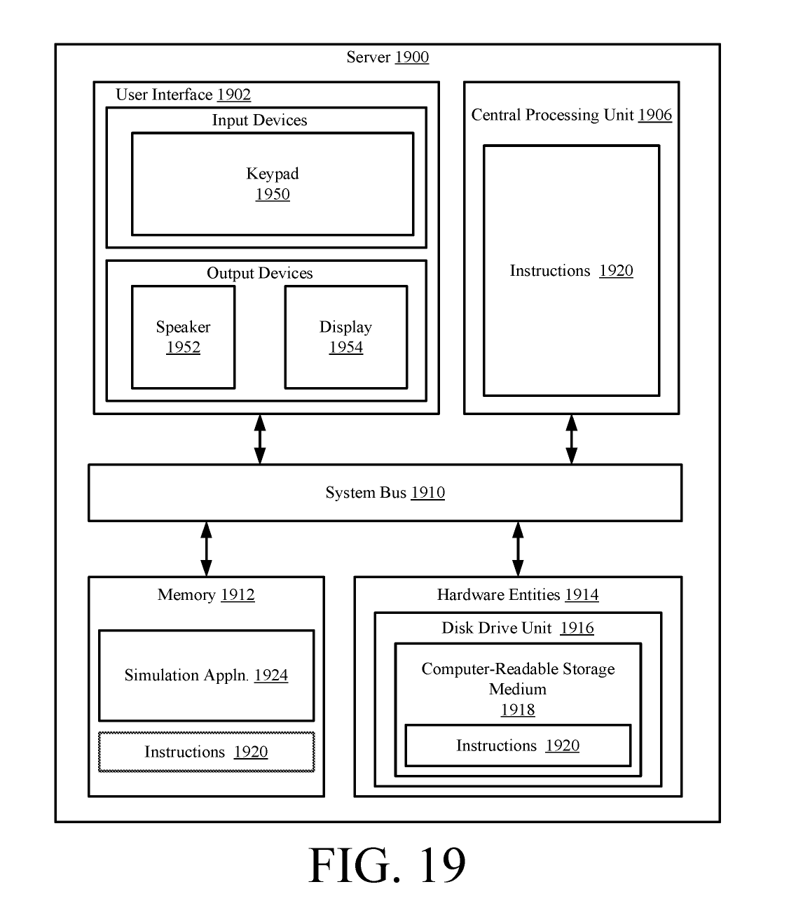

Referring now to FIG. 19, there is provided a schematic illustration of an exemplary architecture for a simulator 1900. Simulators 520 of FIG. 5 and 1150 of FIG. 11 are the same as or similar to simulator 1900. As such, the following discussion of simulator 1900 is sufficient for understanding simulators 520 and 1150.

Notably, the simulator 1900 may include more or less components than those shown in FIG. 19. However, the components shown are sufficient to disclose an illustrative embodiment implementing the present invention. The hardware architecture of FIG. 19 represents one embodiment of a representative simulator configured to facilitate the optimization of thread execution in a target hardware platform. As such, the simulator 1900 of FIG. 19 implements at least a portion of a method for providing such optimized thread execution in a target hardware platform. Some or all the components of the simulator 1900 can be implemented as hardware, software and/or a combination of hardware and software. The hardware includes, but is not limited to, one or more electronic circuits. The electronic circuits can include, but are not limited to, passive components (e.g., resistors and capacitors) and/or active components (e.g., amplifiers and/or microprocessors). The passive and/or active components can be adapted to, arranged to and/or programmed to perform one or more of the methodologies, procedures, or functions described herein.

As shown in FIG. 19, the simulator 1900 comprises a user interface 1902, a CPU 1906, a system bus 1910, a memory 1912 connected to and accessible by other portions of simulator 1900 through system bus 1910, and hardware entities 1914 connected to system bus 1910. The user interface can include input devices (e.g., a keypad 1950) and output devices (e.g., speaker 1952 and/or a display 1954), which facilitate user-software interactions for controlling operations of the simulator 1900.

At least some of the hardware entities 1914 perform actions involving access to and use of memory 1912, which can be a Random Access Memory (“RAM”), a disk driver and/or a Compact Disc Read Only Memory (“CD-ROM”). Hardware entities 1914 can include a disk drive unit 1916 comprising a computer-readable storage medium 1918 on which is stored one or more sets of instructions 1920 (e.g., software code) configured to implement one or more of the methodologies, procedures, or functions described herein. The instructions 1920 can also reside, completely or at least partially, within the memory 1912 and/or within the CPU 1906 during execution thereof by the simulator 1900. The memory 1912 and the CPU 1906 also can constitute machine-readable media. The term “machine-readable media”, as used here, refers to a single medium or multiple media (e.g., a centralized or distributed database, and/or associated caches and servers) that store the one or more sets of instructions 1920. The term “machine-readable media”, as used here, also refers to any medium that is capable of storing, encoding or carrying a set of instructions 1920 for execution by the simulator 1900 and that cause the simulator 1900 to perform any one or more of the methodologies of the present disclosure.

In some embodiments of the present invention, the hardware entities 1914 include an electronic circuit (e.g., a processor) programmed for facilitating the provision of optimized thread execution layouts within a target hardware platform. In this regard, it should be understood that the electronic circuit can access and run a simulation application 1924 installed on the simulator 1900. The software application 1924 is generally operative to facilitate the computation of performance scores (e.g., performance scores 526 of FIG. 5 and/or 1156 of FIG. 11), configuration files (e.g., configuration files 528 of FIG. 5) and/or software deployment templates (e.g., software deployment templates 1158 of FIG. 11). Other functions of the software application 224 are apparent in view of the above discussions.

The advantages of the present technology may include the reduction of the time to tune the performance of software systems. The time is reduced by enabling performance-tuning specialists to obtain performance results in seconds of simulation rather than weeks of empirical tests in normal lab environments. The performance score may give immediate feedback to the specialist, as opposed to having to wait minutes or even hours of tests to see whether or not the thread allocation was optimal.

The advantages of the present technology may also include the reduction of equipment costs required to tune the performance of software systems. The equipment costs may be reduced by no longer requiring actual hardware or even software components to come up with thread management strategies.

The advantages of the present technology may further include better performance of the distributed software system than manually allocating the threads. When using an automatic thread management model, specialists may achieve better performance than when manually configured system at a fraction of the time and cost. When applied to this model, linear programming techniques may reduce the time and improve the quality of the results.

All of the apparatus, methods, and algorithms disclosed and claimed herein can be made and executed without undue experimentation in light of the present disclosure. While the invention has been described in terms of preferred embodiments, it will be apparent to those having ordinary skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those having ordinary skill in the art are deemed to be within the spirit, scope and concept of the invention as defined.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

We claim:

1. A method for optimizing thread execution in a target hardware platform, comprising:
constructing, by an electronic circuit, at least one first matrix populated with a plurality of first cost values representing costs of running a plurality of threads on a plurality of computing cores;
determining a plurality of first performance scores by the electronic circuit, each said first performance score determined based on the plurality of first cost values contained in the first matrix and a respective thread execution layout of a plurality of different thread execution layouts, each said different thread execution layout specifying which threads of a plurality of threads are to respectively run on a plurality of computing cores disposed within the target hardware platform;
selecting, by the electronic circuit, an optimal thread execution layout from the plurality of different thread execution layouts based on the plurality of first performance scores; and
configuring operations of the target hardware platform in accordance with the optimal thread execution layout.

2. The method according to claim 1, further comprising constructing a second matrix that is useful for determining the plurality of first performance scores and which is populated with values determined based on at least one of a modeling formula, a classification of computing cores, attributes of the threads, first affinities of the threads to at least one computing core, second affinities of the threads to other threads, and context switch costs in the target hardware platform.

3. The method according to claim 1, further comprising adjusting values of the first performance scores to prevent too many threads from running on a single computing core.

4. The method according to claim 1, further comprising determining a plurality of second performance scores based on context switch costs in the target hardware platform, where each second performance score is defined by the following mathematical equation
P_{CS}=(t·ln(t)·c)
where P_{CS} is the performance score of context switches, t is the number of threads running in a given computing core, and c is a constant representing a context switch cost set as an attribute of a computing device.

5. The method according to claim 4, wherein the plurality of first and second performance scores are respectively added together to obtain a plurality of third performance scores.

6. The method according to claim 5, wherein the optimal thread execution layout is selected based on the plurality of third performance scores instead of the plurality of first performance scores.

7. The method according to claim 6, wherein at least one of the second performance scores is multiplied by a total amount of a central processing unit's resources being used by all the threads running on the given computing core.

8. The method according to claim 1, wherein each of the plurality of first performance scores is determined by adding at least two cost values of the plurality of first cost values together.

9. The method according to claim 1, further comprising storing a plurality of optimal thread execution layouts in a data store of the target hardware platform.

10. The method according to claim 9, further comprising dynamically re-configuring operations of the target hardware platform in accordance with a select one of the plurality of optimal thread execution layouts which were stored in the data store of the target hardware platform.

11. A thread management system, comprising:
at least one electronic circuit configured to
construct at least one first matrix populated with a plurality of first cost values representing costs of running a plurality of threads on a plurality of computing cores,
determine a plurality of first performance scores by the electronic circuit, each said first performance score determined based on the plurality of first cost values contained in the first matrix and a respective thread execution layout of a plurality of different thread execution layouts, each said different thread execution layout specifying which threads of a plurality of threads are to respectively run on a plurality of computing cores disposed within a target hardware platform,
select an optimal thread execution layout from the plurality of different thread execution layouts based on the plurality of first performance scores, and
facilitate configuration of the target hardware platform's operations in accordance with the optimal thread execution layout.

12. The thread management system according to claim 11, wherein the electronic circuit further comprising constructs a second matrix that is useful for determining the plurality of first performance scores and which is populated with values determined based on at least one of a modeling formula, a classification of computing cores, attributes of the threads, first affinities of the threads to at least one computing core, second affinities of the threads to other threads, and context switch costs in the target hardware platform.

13. The thread management system according to claim 11, wherein the electronic circuit further adjusts values of the first performance scores to prevent too many threads from running on a single computing core.

14. The thread management system according to claim 11, wherein the electronic circuit further determines a plurality of second performance scores based on context switch costs in the target hardware platform, where each second performance score is defined by the following mathematical equation
P_{CS}=(t·ln(t)·c)
where P_{CS} is the performance score of context switches, t is the number of threads running in a given computing core, and c is a constant representing a context switch cost set as an attribute of a computing device.

15. The thread management system according to claim 14, wherein the plurality of first and second performance scores are respectively added together to obtain a plurality of third performance scores.

16. The thread management system according to claim 15, wherein the optimal thread execution layout is selected based on the plurality of third performance scores instead of the plurality of first performance scores.

17. The thread management system according to claim 14, wherein at least one of the second performance scores is multiplied by a total amount of a central processing unit's resources being used by all the threads running on the given computing core.

18. The thread management system according to claim 11, wherein each of the plurality of first performance scores is determined by adding at least two cost values of the plurality of first cost values together.

19. The thread management system according to claim 11, wherein the electronic circuit further stores a plurality of optimal thread execution layouts in a data store of the target hardware platform.

20. The method according to claim 19, wherein operations of the target hardware platform are dynamically re-configured in accordance with a select one of the plurality of optimal thread execution layouts which were stored in the data store of the target hardware platform.
